(19) United States
(12) Patent Application Publication
(10) Pub. No.: US 2024/0291278 A1
(43) Pub. Date: Aug. 29, 2024

(54) SYSTEMS AND METHODS FOR MICROGRID ENERGY MANAGEMENT

(71) Applicant: Sunnova Energy International Inc., Houston, TX (US)

(72) Inventor: Shankar V. Achanta, Frisco, TX (US)

(21) Appl. No.: 18/583,633

(22) Filed: Feb. 21, 2024

Related U.S. Application Data
(60) Provisional application No. 63/448,155, filed on Feb. 24, 2023.

(51) Int. Cl. H02J 3/38; B60L 53/51; B60L 53/63; B60L 55/00; H02J 3/00; H02J 13/00

(52) U.S. Cl. CPC H02J 3/38; B60L 53/51; B60L 53/63; B60L 55/00; H02J 3/003; H02J 13/00002; H02J 2300/24

(57) ABSTRACT

This disclosure relates to systems and methods for operating a microgrid power system. Rather than configuring the microgrid power system statically, the microgrid system may be operated using dynamic optimization. Dynamic optimization may entail controlling different power resources in a microgrid power system to decrease the cost or increase the efficiency of the microgrid system based on certain factors. These include present output potential or expected output potential; present cost or expected cost based on the indications of weather conditions and energy market conditions; present power consumption rates associated with each electrical load of the microgrid power system and expected power consumption rates based on the indications of weather conditions; and present and expected power consumption costs associated with each electrical load of the plurality of electrical loads based on the weather conditions and the energy market conditions.

### CROSS-REFERENCE TO RELATED APPLICATIONS

This application claims priority to and benefit of U.S. Provisional Application No. 63/448,155, filed Feb. 24, 2023, entitled “Hybrid Energy Management System and Method,” which is incorporated herein by reference in its entirety for all purposes.

### BACKGROUND

This disclosure relates to energy management in microgrid systems. In particular, this disclosure relates to dynamically routing power generated or received by the microgrid system to one or more electrical loads within the microgrid system or a main power grid.

A microgrid system may receive energy from a main power grid and may include multiple power sources for generating or receiving electric power locally, such as a photovoltaic system, a windmill, watermill or other hydroelectric turbine, batteries, fuel cells, electric generators, or any other appropriate distributed energy resource (DER). One or more of these systems for receiving or generating electric power may be used to provide electric power to a variety of electrical loads. In some instances, the microgrid may be operated statically—that is, various electrical loads of the microgrid would receive power by one or more power sources, and the source-load relationship would remain unchanged for the duration of operation of the microgrid. However, the various localized energy sources may vary in production capability, production efficiency, and/or costliness depending on weather conditions, market conditions, and conditions of the electrical loads.

### BRIEF DESCRIPTION OF THE DRAWINGS

FIG. 1 is a schematic diagram of a dynamic microgrid system that may be operated to monitor, capture, and combine signals from energy generating resources, electrical loads, a main power grid, and so on, in accordance with an embodiment;

FIG. 2 is a block diagram of the dynamic microgrid management circuitry described with respect to FIG. 1, in accordance with an aspect of the present disclosure;

FIG. 3 is a schematic diagram of a hybrid dynamic microgrid system including hybrid management circuitry that may be implemented in addition to or as an alternative to the dynamic microgrid management circuitry described with respect to FIG. 1 and FIG. 2, in accordance with an aspect of the present disclosure; and

FIG. 4 is a flowchart of a method for dynamically adjusting the dynamic microgrid system described with respect to FIG. 1 or the hybrid microgrid system described with respect to FIG. 3, in accordance with an aspect of the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be noted that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase “A or B” is intended to mean A, B, or both A and B.

A microgrid is a small-scale, localized energy system capable of operating independently or alongside a main power grid. For example, when the microgrid is in an off-grid mode (sometimes referred to as “island mode”), the microgrid may be electrically isolated from the main grid and may only generate its own power, such as via renewable power sources. The microgrid may generate its own power via one or more localized power sources, including but not limited to solar generation via photovoltaic array, wind generation via windmill, hydroelectric generation via a watermill or turbine, or generation via an energy source such as one or more batteries, one or more fuel cells, one or more generators, or any other appropriate distributed energy resource (DER). In an on-grid mode, the microgrid may be fully or partially integrated into a main power grid, such that the microgrid supplies electric power to various electrical loads entirely via the electric power received from the main power grid, or may supplement the power received from the main power grid with localized power sources described above.

In a conventional microgrid power system there may be no dynamic source detection, load detection, or optimization. In these systems, the microgrid may operate off-grid or operate on-grid with set energy production from one or more localized power sources. In general, the microgrid may operate statically. However, this may be disadvantageous as the various localized energy sources may vary in production capability, production efficiency, and/or costliness depending on weather, market conditions, and requirements of one or more of the electrical loads. Accordingly, it may be advantageous to implement a microgrid system capable of dynamic optimization.

As used herein, dynamic optimization refers to electrically or communicatively coupling or decoupling various electrical loads or electrical sources, performing load balancing between new or existing loads and the available power sources, or otherwise adjusting the proportion of power consumed and/or supplied by the available power sources in a manner desirable to a user. For example, during a sunny day, one or more photovoltaic arrays may be leveraged to generate power for the microgrid, and consequently the microgrid may reduce or block energy received from the main power grid, which may save money in reduced energy consumption costs. Further, if a microgrid is equipped with additional energy storage, such as a battery or an electric vehicle (EV), the microgrid may provide excess energy (e.g., excess energy produced via the photovoltaic array on a sunny day) to the energy storage for later use. Additionally or alternatively, the microgrid may determine that export rates exceed retail rates (or exceed a threshold price) and export all or a portion of the excess energy to the main grid. Additional dynamic microgrid optimization features will be discussed below. It should be noted that “optimization” may merely indicate an improvement in operation, and does not necessarily suggest that the optimization actions or optimization features will result in the most efficient operation possible, the least costly operation possible, and so on.

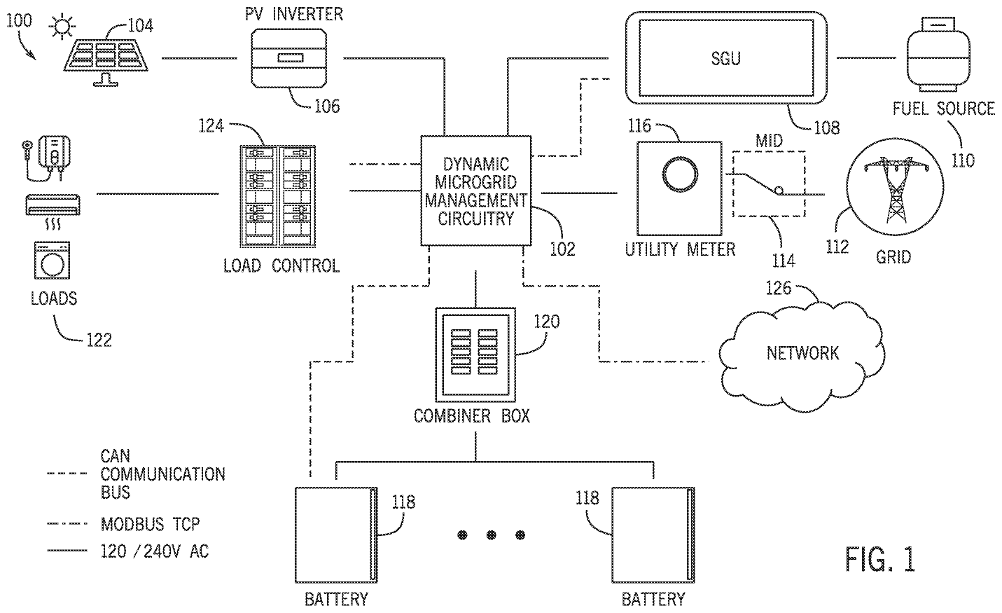

FIG. 1 is a schematic diagram of a dynamic microgrid system 100 to monitor, capture, and combine signals from energy generating resources, electrical loads, a main power grid, and so on, according to embodiments of the present disclosure. The dynamic microgrid system 100 may include dynamic microgrid management circuitry 102 designed to receive, manage, and distribute energy received via a photovoltaic array 104 and an inverter 106, via a secondary generation unit (SGU) 108 and a corresponding fuel source 110, via a main grid 112 through a microgrid interconnect device (MID) 114 and a utility meter 116, and/or via an energy storage system (ESS) which may include a plurality of energy storage devices (e.g., batteries 118) coupled to the dynamic microgrid management circuitry 102 via a combiner box 120. The dynamic microgrid management circuitry 102 may manage and distribute the energy to a variety of electrical loads 122 via load control circuitry 124. The dynamic microgrid management circuitry 102 may send control signals to the various subsystems described above via a contact output embedded in the dynamic microgrid management circuitry 102. The dynamic microgrid management circuitry 102 may send control signals to the various electrical loads 122 via the load control. The control signals may cause the loads 122 to reduce power or shut off completely. Additionally or alternatively, the dynamic microgrid management circuitry 122 may send a signal to the load control circuitry 124 causing the load control circuitry 124 to shut off a circuit breaker or other switch to an electrical load 122. In this manner, the load control circuitry 124 may facilitate load shedding. It should be noted that the power sources and electrical loads 122 illustrated in the dynamic microgrid system 100 are not intended to be limiting, and the dynamic microgrid system 100 may include any number of additional power sources (e.g., wind turbine, water turbine) and/or any number of additional electrical loads (e.g., an electric vehicle).

The dynamic microgrid management circuitry 102 may receive and manage electric power generated by the photovoltaic array 104 and converted by the inverter 106 from direct current (DC) electricity into alternating current (AC) electricity for use by the various electrical loads 122 of the dynamic microgrid system 100. The inverter 106 may include one or more module-level power electronics (MPLE) and/or one or more microinverters. The dynamic microgrid management circuitry 102 may track electric power generated by the photovoltaic array 104 and store a database of historical power data associated with the photovoltaic array 104. The dynamic microgrid management circuitry 102 may cross reference the historical power data associated with the photovoltaic array 104 with data received from a network 126. This may enable the dynamic microgrid management circuitry 102 to process the data and make a prediction as to how much solar power the photovoltaic array 104 may produce over a given time period based on the time of year and present or predicted weather conditions. For example, these predictions or determinations may be made by a machine learning engine executing on the dynamic microgrid management circuitry 102 or on the network 126. In some embodiments, the predictions or determinations are made via the network 126, and the network 126 sends a control signal to the dynamic microgrid management circuitry 102 to cause the dynamic microgrid management circuitry 102 to perform an action based on the predictions or determinations made by the machine learning engine.

The dynamic microgrid management circuitry 102 may additionally or alternatively receive and manage power generated by the SGU 108. The SGU 108 may include a standby generator such as a diesel, propane, or natural gas generator. The SGU 108 may also include a fuel cell, in which case the fuel source 110 may include hydrogen, natural gas, methanol, or any other appropriate fuel used by a fuel cell. The dynamic microgrid management circuitry 102 may monitor fuel levels in the fuel source 110 continuously or periodically, and may also collect historical data for the rate of fuel consumption of the SGU 108. The dynamic microgrid management circuitry 102 may factor in the present fuel levels, the present consumption data for the SGU 108, historical consumption data for the SGU 108, and data collected from other similar SGUs to determine whether to utilize energy from the SGU 108, other local microgrid power sources (e.g., the photovoltaic array 104), or the main grid 112 to power the dynamic microgrid system 100. The dynamic microgrid management circuitry 102 may cross reference the historical power data associated with the SGU 108 with data received from a network 126. This may enable the dynamic microgrid management circuitry 102 to process the data and make a prediction as to how much power the SGU 108 may produce over a given time period based on the time of year and present or predicted weather conditions. For example, these predictions or determinations may be made by a machine learning engine executing on the dynamic microgrid management circuitry 102 or on the network 126. In some embodiments, the predictions or determinations are made via the network 126, and the network 126 sends a control signal to the dynamic microgrid management circuitry 102 to cause the dynamic microgrid management circuitry 102 to perform an action based on the predictions or determinations made by the machine learning engine.

The dynamic microgrid management circuitry 102 may additionally or alternatively receive and manage power from various batteries 118 of a battery system, an energy storage system (ESS), and so on. The combiner box 120 may include hardware capable of combining respective output of several energy strings. Each energy string may be coupled to an energy conductor which lands on a fuse terminal and the output of the fused inputs are combined onto a single conductor that connects the combiner box 120 to an inverter. The dynamic microgrid management circuitry 102 may continuously or periodically detect the power level of batteries such that the dynamic microgrid management circuitry 102 may determine whether to charge or discharge the batteries depending on weather, energy market, and load conditions. The dynamic microgrid management circuitry 102 may determine whether or not to charge or discharge the batteries 118 based on a threshold charge held by the batteries 118.

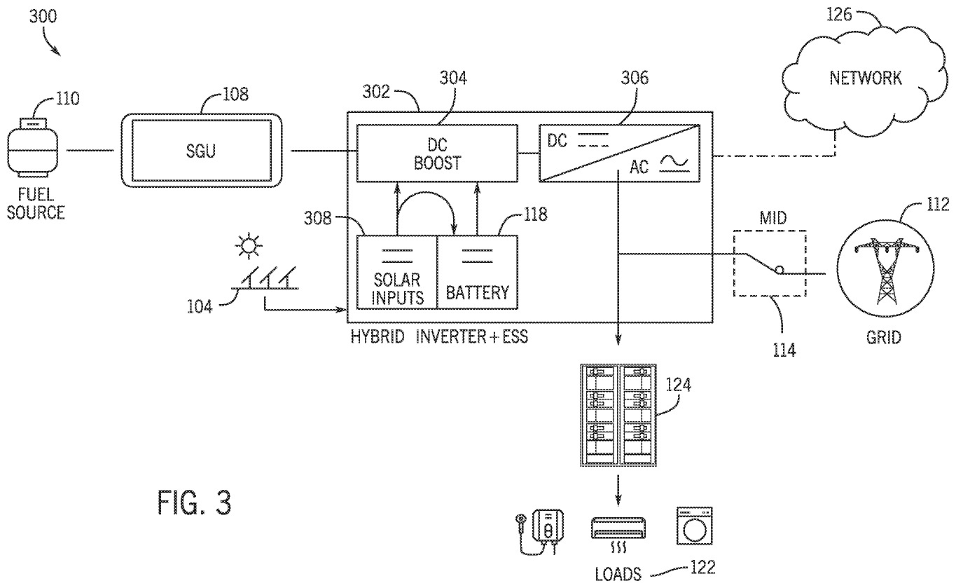

The threshold may be set by a user or determined by the machine learning algorithm, and may be set for varying conditions, such as off-grid mode, on-grid mode, and so on. For example, a user may input (e.g., via the I/O ports 208 or the display 210) a minimum battery charge of 80% while the dynamic microgrid system 100 is in an on-grid mode. That is, while connected to the main grid 112, the dynamic microgrid system 100 may ensure that the batteries are never discharged below 80% (e.g., to preserve the batteries for a potential off-grid mode). While an illustrative example of an 80% threshold is used, it should be noted that any battery charge threshold may be used, such as 90%, 70%, 50%, 25%, and so on. Similarly, the user may set a reserve threshold such that the dynamic microgrid management circuitry 102 preserves some level of charge for emergency situations. The reserve threshold may include any percentage charge, such as 10% or more, 20% or more, 30% or more, and so on. The user may also specify that no threshold applies when one or more conditions have been met, such as the fuel source 110 of the SGU 108 is empty (or below a threshold). As will be discussed further below with respect to the hybrid dynamic microgrid system in FIG. 3 below, the batteries 118 may alternately or simultaneously include electrical loads (when charging) or power sources (when discharging), depending on need.

The dynamic microgrid management circuitry 102 may additionally or alternatively receive and manage power received from the main grid 112. The main grid 112 may include a distribution grid, a substation, a transmission grid, or additional interconnected microgrids. The main grid 112 may be coupled to decoupled from the dynamic microgrid system 100 via the MID 114. The utility meter 116 may include hardware capable of tracking consumption of electrical energy received from the main grid 112. Bi-directional utility meters may allow energy to be exported from the local generation resources back to the utility and meter this exported energy. Advanced Metering Infrastructure (AMI), or smart digital meter, have dual registers to track inflow and outflow of power from the home. Smart meters also provide granularity (e.g., at daily or hourly periods, or instantaneously) into a customer's energy consumption from the main grid 112 and energy returned, or sold back, to the main grid 112. The dynamic microgrid management circuitry 102 may receive energy market conditions (e.g., import and export prices) via the network 126 and determine (e.g., via the machine learning engine) whether to operate in an on-grid or off-grid mode.

For example, if energy import prices are high, the dynamic microgrid management circuitry 102 may close the MID 114 and receive power from the main grid 112. The dynamic microgrid management circuitry 102 may determine, via the machine learning engine, how much power to pull from the main grid 112 based on the power needed by the electrical loads 122 and power capacity of the generating resources of the microgrid. To make this determination, the machine learning engine may consider import prices, battery level of the batteries 118, present and anticipated power expectancy from the photovoltaic array 104, fuel level of the fuel source 110, and so on. As previously stated, this determination may be made locally on the dynamic microgrid management circuitry 102 or made in the cloud and commands relayed via the network 126. The dynamic microgrid management circuitry 102 may cross reference the historical power data associated with the photovoltaic array 104 with data received from a network 126. This may enable the dynamic microgrid management circuitry 102 to process the data and make a prediction as to the cost of power over a given time period based on the time of year, present or predicted weather conditions, and present or predicted market conditions. For example, these predictions or determinations may be made by the machine learning engine executing on the dynamic microgrid management circuitry 102 or on the network 126. In some embodiments, the predictions or determinations are made via the network 126, and the network 126 sends a control signal to the dynamic microgrid management circuitry 102 to cause the dynamic microgrid management circuitry 102 to perform an action based on the predictions or determinations made by the machine learning engine.

In another example, if energy consumption prices are high, or if the main grid 112 goes down, the dynamic microgrid management circuitry 102 may disconnect the dynamic microgrid system 100 from the main grid 112 by opening the MID 114, which may effectuate an off-grid or “island” mode. In the off-grid mode, the dynamic microgrid system 100 is powered self-sufficiently via the various energy generating resources, such as the photovoltaic array 104, the SGU 108, the batteries 118, and so on. In yet another example, if energy export prices are high (e.g., above a threshold dollar amount), the dynamic microgrid management circuitry 102 may send a signal to the generation resources and the MID 114 to redirect power generated by the generation resources and/or stored in the batteries 118 to the main grid 112. Moreover, closing the MID 114 may enable the dynamic microgrid system 100 to provide power to the various electrical loads 122 from the main grid 112 while the batteries 118 charge (e.g., via the electric power received from the photovoltaic array 104). Additionally or alternatively, the power from the main grid 112 may charge the batteries 118.

The dynamic microgrid management circuitry 102 may route energy from any available energy resource to one or more of the electrical loads 122 via the dynamic microgrid management circuitry 102 and the load control circuitry 124. The electrical loads 122 may include home appliances, heating, ventilation, and air conditioning (HVAC) systems, industrial and/or commercial equipment, electric vehicles, and so on. As will be discussed in greater detail below, the dynamic microgrid management circuitry 102 may determine power drawn by each of the respective electrical loads 122, anticipated power to be drawn by each of the respective electrical loads 122, and costs associated thereof, and couple or decouple the loads, or direct the power sources to produce additional or less power based thereon. The dynamic microgrid management circuitry 102 may send control signals to the load control circuitry 124 locally to throttle the energy consumption of the electrical loads 122 when there is less than adequate power supply (e.g., less than adequate supply of solar energy via the photovoltaic array 104 on a cloudy day), when the grid utility rates are high during certain time windows, and so on.

As will be discussed in greater detail below, the dynamic microgrid management circuitry 102 may leverage electric vehicle batteries as power generating resources, or may leverage home appliances, such as electric water heaters and HVAC units, as thermal energy storage media if additional power generation or power storage media are desired. The dynamic microgrid management circuitry 102 may receive control signals remotely from the network 126 where the machine learning engine determines the recipe for the load control and the energy management of the site. The dynamic microgrid management circuitry 102 may act as a site monitor and controller to continuously monitor local signals from the generation resources, the electrical loads 122, weather conditions (e.g., via the network 126), electrical load usage patterns, as well as the remote signals (e.g., from the network 126) for taking actions.

The connections between different components in the dynamic microgrid system 100 are shown as wired connections delivering 120 Volts or 240 Volts in Alternating Current (AC) (solid line), ethernet wiring using Modbus TCP/IP connectivity (intermittent lines), and a controller area network (CAN) communication bus (intermittent lines with dots). The sub-components in the system shown in FIG. 1 may communicate via other methods of communication to exchange data and control signals. In some embodiments, the dynamic microgrid system 100 of FIG. 1 comprises home appliances and lighting devices as loads that may be managed via energy management system through continuous monitoring of energy and consumer behavior. The dynamic microgrid system 100 may communicate locally through wired or wireless connections, such as local area network (LAN), Bluetooth, WiFi, or power line carrier (PLC) communication.

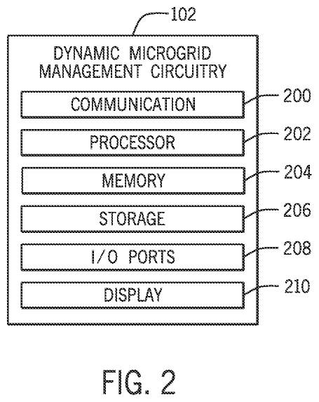

FIG. 2 is a block diagram of the dynamic microgrid management circuitry 102, according to an embodiment of the present disclosure. For example, the dynamic microgrid management circuitry 102 may include a communication component 200, a processor 202, a memory 204, a storage 206, input/output (I/O) ports 208, a display 210, and the like. The communication component 200 may include a wireless or wired communication component that may facilitate communication between the dynamic microgrid management circuitry 102, electric power sources in the dynamic microgrid system 100 (e.g., the photovoltaic array 104, the SGU 108, the fuel source 110, the batteries 118), the electrical loads 122, the utility meter 116, the MID 114 a network, the network 126, and the like. Additionally, the communication component 200 may facilitate data transfer to the dynamic microgrid management circuitry 102, such that the dynamic microgrid management circuitry 102 may receive data from the other components depicted in FIG. 1, such as receiving command signals from the network.

The processor 202 may include any type of computer processor or microprocessor capable of executing computer-executable code, such as the machine learning engine. The processor 202 may also include multiple processors that may perform the operations described below. The memory 204 and the storage 206 may include any suitable articles of manufacture that can serve as media to store processor-executable code, data, or the like. These articles of manufacture may represent computer-readable media (e.g., any suitable form of memory or storage) that may store the processor-executable code used by the processor 202 to perform the presently disclosed techniques. The memory 204 and the storage 206 may also be used to store data, various other software applications for analyzing the data, and the like. The memory 204 and the storage 206 may represent non-transitory computer-readable media (e.g., any suitable form of memory or storage) that may store the processor-executable code used by the processor 202 to perform various techniques described herein. It should be noted that non-transitory merely indicates that the media is tangible and not a signal.

The I/O ports 208 may be interfaces that may couple to other peripheral components such as input devices (e.g., keyboard, mouse), sensors, input/output (I/O) modules, and the like. In one embodiment, the display 210 may be a touch display capable of receiving inputs from a user. It should be noted that the components described above with regard to the dynamic microgrid management circuitry 102 are exemplary components and the dynamic microgrid management circuitry 102 may include additional or fewer components as shown. In addition, although the components are described as being part of the dynamic microgrid management circuitry 102, the components may also be part of any suitable computing device described herein such as the photovoltaic array 104, the SGU 108, the batteries 118, the electrical loads 122, the load control circuitry 124, the combiner box 120, the inverter 106, the utility meter 116, and the like to perform the various operations described herein.

Keeping this in mind, the present embodiments may enable the dynamic microgrid management circuitry 102 to collect data from the variety of power sources and the electrical loads 122. Further, present embodiments may incorporate machine learning and/or artificial intelligence that observes routine operational metrics and establishes thresholds based on historical data, real time operational data, component specifications, manufacturer data, and so forth. As will be discussed in greater detail below, the dynamic microgrid management circuitry 102 may couple or decouple one or more power sources or electrical loads, may throttle the power sources or electrical loads, may switch certain resources from an electrical load 122 to an energy generating resource or vice versa, may switch the dynamic microgrid system 100 from an on-grid to an off-grid mode, and so on.

FIG. 3 is a schematic diagram of a hybrid dynamic microgrid system 300 including hybrid management circuitry 302 that may be implemented in addition to or as an alternative to the dynamic microgrid system 100, according to embodiments of the present disclosure. The hybrid dynamic microgrid system 300 may include various power generation resources and subsystems as described with respect to the dynamic microgrid system 100 of FIG. 1. For instance, the hybrid dynamic microgrid system 300 may include the SGU 108 and corresponding fuel source 110, the photovoltaic array 104, a MID 114 coupled between hybrid management circuitry 302 and the main grid 112, and so on. The hybrid dynamic microgrid system 300 may include various electrical loads 122 that may be coupled to load control circuitry 124 similarly as to what was described with respect to FIG. 1. The hybrid management circuitry 302 may receive AC and DC power and convert and/or distribute the power to one or more of the electrical loads 122. The power may be distributed based on determinations made by a machine learning engine similarly as described with respect to FIG. 1.

The hybrid management circuitry 302 includes DC boost circuitry 304 that may receive input from the SGU 108, photovoltaic array 104, or batteries 118, and boost the DC power to facilitate DC/AC conversion via a hybrid inverter 306. In some embodiments, the hybrid management circuitry 302 may receive DC power from the SGU 108 and either store the DC power in batteries 118 or convert the DC power to AC power via the hybrid inverter 306. The AC power may then be provided to the various electrical loads 122 via the load control circuitry 124 or exported to the main grid 112 via the MID 114.

Similarly, the hybrid management circuitry 302 may receive DC power generated by photovoltaic array 104 at the solar inputs 308. The hybrid management circuitry 302 may send a signal to the photovoltaic array 104 and/or the batteries 118 to cause power generated by the photovoltaic array 104 be stored in the batteries 118 of the hybrid management circuitry 302. Additionally or alternatively, the hybrid management circuitry 302 may send a signal to the photovoltaic array 104 and/or DC boost circuitry 304 to cause the power generated by the photovoltaic array 104 to be provided to the DC boost circuitry 304 for DC power boost and then to the hybrid inverter 306 for conversion to AC power. The AC power may then be supplied to the electrical loads 122 via the load control circuitry 124 and/or exported to the main grid 112. Additionally, the hybrid inverter 306 may receive AC power from the grid, convert the AC power to DC power and use the DC power to charge the batteries 118 of the hybrid management circuitry 302. Additionally, the hybrid inverter 306 may enable the hybrid management circuitry 302 to treat certain loads-such as the battery of an electric vehicle—as generation resources. That is, the hybrid inverter 306 may receive the power from the electric vehicle and provide that power to other electrical loads, or may store that power in the batteries 118.

As previously mentioned, in the dynamic microgrid system 100 described with respect to FIG. 1, the various generation subsystems may be controlled by a contact output embedded in the dynamic microgrid management circuitry 102. However, in the hybrid dynamic microgrid system 300 the contact output that controls the generation subsystems and resources within those subsystems may be embedded in the load control circuitry 124. In other embodiments, the contact output may be embedded in the MID 114. As previously stated, in some embodiments, the dynamic microgrid system 100 may include the hybrid dynamic microgrid system 300. Indeed, in some embodiments, the dynamic microgrid management circuitry 102 may include some or all components of the hybrid management circuitry 302, such that the dynamic microgrid management circuitry 102 may be capable of AC/DC and DC/AC conversion.

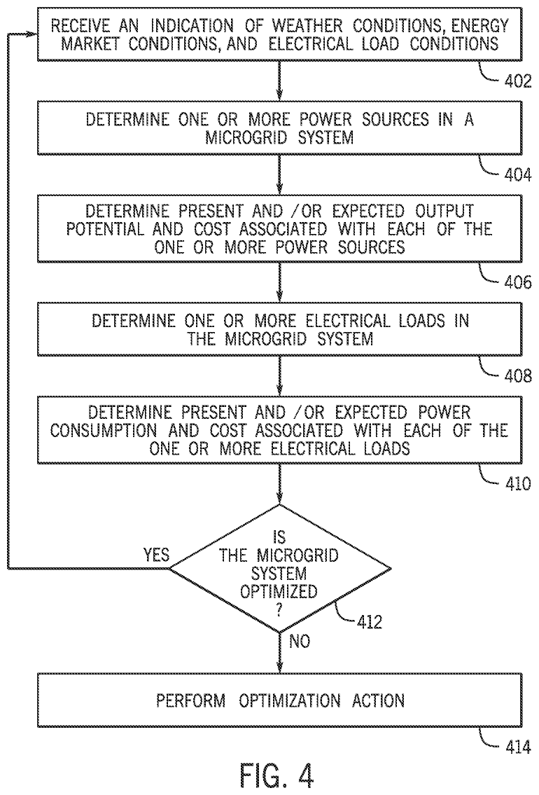

FIG. 4 is a flowchart of a method 400 for dynamically adjusting the dynamic microgrid system 100 or the hybrid dynamic microgrid system 300, according to embodiments of the present disclosure. Any suitable device (e.g., a controller) that may control components of the dynamic microgrid system 100 or the hybrid dynamic microgrid system 300, such as the processor 202 of each of these devices or systems, may perform the method 400. In some embodiments, the method 400 may be implemented by executing instructions stored in a tangible, non-transitory, computer-readable medium, such as the memory 204 or storage 206, using the processor 202. For example, the method 400 may be performed at least in part by one or more software components, such as an operating system, one or more software applications, and the like, of the dynamic microgrid management circuitry 102 or the hybrid management circuitry 302. While the method 400 is described using steps in a specific sequence, it should be understood that the present disclosure contemplates that the described steps may be performed in different sequences than the sequence illustrated, and certain described steps may be skipped or not performed altogether. Moreover, while the steps below may be discussed as being performed by the dynamic microgrid management circuitry 102, it should be noted that the steps may be performed by the hybrid management circuitry 302, or a device of the network 126.

In process block 402, the dynamic microgrid management circuitry 102 may receive an indication of weather conditions, energy market conditions, and electrical load conditions. The indications of the weather conditions and the energy market conditions may be received via the network 126, while the indications of the electrical load conditions may be received from the electrical loads 122 themselves (e.g., via monitoring by the dynamic microgrid management circuitry 102) or from the load control circuitry 124. Additionally, as the dynamic microgrid management circuitry 102 may be continuously or periodically monitoring the electrical loads 122, the dynamic microgrid management circuitry 102 may have the indications of past or present electrical load conditions stored in the memory 204 or the storage 206.

In process block 404, the dynamic microgrid management circuitry 102 may determine one or more electric power sources in the dynamic microgrid system 100. The power sources may include the photovoltaic array 104, the SGU 108 and the fuel source 110, the main grid 112, the batteries 118, or any other appropriate electric power source that may be present in the dynamic microgrid system 100. In process block 406, the dynamic microgrid management circuitry 102 may determine present output potential of each of the power sources. The dynamic microgrid management circuitry 102 may determine the present output potential based on present weather conditions (e.g., for the photovoltaic array 104, a wind turbine, and so on) based on fuel levels (e.g., for the SGU 108), battery storage levels (e.g., for the batteries 118), connectivity to the main grid 112, and so on. Likewise, the dynamic microgrid management circuitry 102 may determine expected output potential based on the weather forecast, fuel levels, battery storage levels, and so on. The dynamic microgrid management circuitry 102 may combine the present and/or expected output potential of the various power sources to determine an overall microgrid-level present and/or expected output potential. In the process block 406, the dynamic microgrid management circuitry 102 may determine cost associated with each of the power sources based on weather data, weather forecast, fuel levels, battery storage levels, fuel prices, and electricity import costs. For example, if the dynamic microgrid management circuitry 102 determines that the photovoltaic array 104 has been outputting sufficient power to run the dynamic microgrid system 100 and the forecast predicts sunny conditions for the rest of the day, the dynamic microgrid management circuitry 102 may determine that the costs associated with the power sources is low.

In process block 408, the dynamic microgrid management circuitry 102 may determine one or more electrical loads 122 in the dynamic microgrid system 100 by continuous or periodic monitoring, or via the load control circuitry 124. In process block 410, the dynamic microgrid management circuitry 102 may determine present and/or expected power consumption of the electrical loads 122. The dynamic microgrid management circuitry 102 may determine present power consumption based on continuous or periodic monitoring, or via indication from the load control circuitry 124. The dynamic microgrid management circuitry 102 may determine expected power consumption based on electrical load conditions (e.g., present consumption, historical power consumption data), weather forecast data, and/or data of similar premises. For example, if the dynamic microgrid system 100 includes a residential home, the dynamic microgrid management circuitry 102 may analyze data of other residential microgrids in the same geographical region (e.g., same city, same neighborhood). This may give the dynamic microgrid management circuitry 102 insight into the total power consumed by the dynamic microgrid system 100 based on electrical loads such as the HVAC system, the presence of EVs, and so on.

The dynamic microgrid management circuitry 102 may determine costs associated with each of the electrical loads 122. To accomplish this, the dynamic microgrid management circuitry 102 may analyze the energy market conditions received via the network 126, the cost of the fuel associated with the fuel source 110 received via the network 126, and the expected power consumption of the electrical loads 122. In query block 412, the dynamic microgrid management circuitry 102 may determine whether the dynamic microgrid system 100 is optimized based on the information determined via the process blocks 402, 404, 406, 408, and 410. The optimization determination may be based on weather conditions, energy market conditions, power source conditions, and electrical load conditions. As a first example, if the cost of pulling electric power off of the main grid 112 is above a threshold price, the dynamic microgrid management circuitry 102 may not consider the dynamic microgrid system 100 optimized. The dynamic microgrid management circuitry 102 may determine whether the price of electricity is above a local average. For example, if the local average price of electricity (as indicated by data received from the network 126) is 15 cents per kilowatt-hour (kWh), the dynamic microgrid management circuitry 102 may determine that the dynamic microgrid system 100 is not optimized if the price of electricity exceeds 15 cents per kWh. Additionally, the dynamic microgrid management circuitry 102 may determine that the dynamic microgrid system 100 is not optimized if the price of electricity is a certain percentage above the average (e.g., 10% above average, 20% above average, and so on).

As a second example, if the photovoltaic array 104 is producing enough electricity to power all of the electrical loads 122, but the dynamic microgrid system 100 is using power from the main grid 112, the dynamic microgrid management circuitry 102 may not consider the dynamic microgrid system 100 to be optimized. Additionally or alternatively, the dynamic microgrid management circuitry 102 may determine if any of the power sources, such as the photovoltaic array 104, are producing (or are capable of producing) a threshold amount of power. If the power sources are capable of producing at or above the threshold amount of power, the dynamic microgrid management circuitry 102 may determine the dynamic microgrid system 100 to be optimized. If the power sources are producing below the threshold amount of power, the dynamic microgrid management circuitry 102 may determine that the dynamic microgrid system 100 is not optimized.

As a third example, if the batteries 118 are fully charged, the photovoltaic array 104 is producing enough electricity to power all of the electrical loads 122, and the export prices are above a threshold price, the dynamic microgrid management circuitry 102 may not consider the dynamic microgrid system 100 to be optimized. For example, the dynamic microgrid management circuitry 102 may receive local average export prices from the network 126. If the dynamic microgrid management circuitry 102 determines that average export prices are 10 cents per kWh exported and the current export price is 12 cents per kWh, but the dynamic microgrid system 100 is not exporting to the main grid 112, the dynamic microgrid management circuitry 102 may determine that the dynamic microgrid system 100 is not optimized. Additionally or alternatively, the dynamic microgrid management circuitry 102 may export (or favor exporting) if export prices are above the local average export price or below but within a percentage threshold of the local average export price (e.g., within 10% of average export prices, within 50% of average export prices, and so on). Additionally or alternatively, the dynamic microgrid management circuitry 102 may be programmed such that it determines an absolute export price. For example, the dynamic microgrid management circuitry 102 may be programmed to export any excess energy when export prices are above 5 cents per kWh or more, 7 cents per kWh or more, 10 cents per kWh or more, and so on.

If, in the query block 412, the dynamic microgrid management circuitry 102 does not determine the dynamic microgrid system 100 to be optimized, the dynamic microgrid management circuitry 102 may, in process block 414, perform one or more optimization actions. Continuing with the first and the second examples above, to enhance performance of the dynamic microgrid system 100, the dynamic microgrid management circuitry 102 may switch away from the main grid 112 by opening the MID 114 and transitioning to one of the-off grid power sources, such as solar power, power from the batteries 118, or power from the SGU 108. Continuing with the third example, to enhance performance of the dynamic microgrid system 100, the dynamic microgrid management circuitry 102 may discharge the batteries to export the discharged electricity to the main grid 112 and recharge the batteries with the excess solar power. This may enhance performance by increasing the passive income obtained by the dynamic microgrid system 100.

The optimization actions may, in other instances, include load shedding, coupling to the main grid 112 to supplement the dynamic microgrid system 100 with power from the main grid, and any other appropriate action that may decrease the cost of, increase the reliability of, or increase income received by the dynamic microgrid system 100. If the dynamic microgrid management circuitry 102 determines, in the query block 412, that the system is optimized (or if the performance of the dynamic microgrid system 100 is enhanced), then the dynamic microgrid management circuitry 102 may return to the process block 402 and continue to the monitor the dynamic microgrid system 100.

Indeed, the embodiments set forth in the present disclosure may be susceptible to various modifications and alternative forms, specific embodiments have been shown by way of example in the drawings and have been described in detail herein. However, it may be noted that the disclosure is not intended to be limited to the particular forms disclosed. The disclosure is to cover all modifications, equivalents, and alternatives falling within the spirit and scope of the disclosure as defined by the following appended claims. In addition, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). For any claims containing elements designated in any other manner, however, it is intended that such elements are not to be interpreted under 35 U.S.C. 112(f).

What is claimed is:

1. A method, comprising:
receiving, via a processor, an indication of weather conditions, energy market conditions, or both;
determining presence of a plurality of power resources in a microgrid system;
determining present output potential, expected output potential, or both associated with each respective power resource of the plurality of power resources;
determining present cost, expected cost, or both associated with each respective power resource of the plurality of power resources based on the indications of the weather conditions and the energy market conditions;
determining a plurality of electrical loads associated with the microgrid system;
determining present power consumption rates associated with each electrical load of the plurality of electrical loads;
determining expected power consumption rates associated with each electrical load of the plurality of electrical loads based on the indications of the weather conditions;
determining present and expected power consumption costs associated with each electrical load of the plurality of electrical loads based on the indications of the weather conditions and the energy market conditions; and
performing an action to decrease cost of operating the microgrid system, increase efficiency of the microgrid system, or both.

2. The method of claim 1, wherein the action comprises determining excess power generated by one or more power resources of the plurality of power resources and transmitting an input signal to the one or more power resources, causing the one or more electric power resources to export at least a portion of the excess power to a power grid based on the weather conditions and the energy market conditions.

3. The method of claim 1, wherein the action comprises determining excess power generated by one or more power resources of the plurality of power resources, and sending a signal to the one or more power resources, causing the one or more power resources to store excess generated power in a battery based on the weather conditions and the energy market conditions.

4. The method of claim 1, wherein the action comprises sending an input signal to load control circuitry coupled to the plurality of electrical loads, the input signal causing the load control circuitry to shed one or more electrical loads of the plurality of electrical loads based on determining that the microgrid system is in an off-grid mode.

5. The method of claim 1, comprising determining an expected output potential of the microgrid system based on the expected output potential associated with each respective power resource of the plurality of power resources.

6. The method of claim 5, comprising shedding one or more electrical loads of the plurality of electrical loads based on determining that the expected output potential of the microgrid system falls below a threshold power output.

7. The method of claim 5, comprising activating a secondary generation unit based on determining that the expected output potential of the microgrid system falls below a threshold power output.

8. The method of claim 5, comprising activating a backup battery storage based on determining that the expected output potential of the microgrid system falls below a threshold power output.

9. A microgrid system, comprising:
a photovoltaic array comprising a plurality of photovoltaic panels;
a secondary generation unit;
an energy storage system;
an electrical load; and
dynamic microgrid management circuitry configured to:
receive an indication of weather conditions, energy market conditions, or both from a network;
determine present output potential, expected output potential, or both associated with the photovoltaic array, the secondary generation unit, and the energy storage system;
determine present power consumption rates associated with the electrical load based on the weather conditions and data received from the electrical load;
determine present and expected power consumption costs associated with the electrical load based on the weather conditions and the energy market conditions; and
perform an action to decrease cost of operating the microgrid system, increase efficiency of the microgrid system, or both.

10. The microgrid system of claim 9, wherein the electrical load comprises a battery of an electric vehicle.

11. The microgrid system of claim 10, wherein the dynamic microgrid management circuitry is configured to send a signal to cause the photovoltaic array, the secondary generation unit, and/or the energy storage system to store power in the battery of the electric vehicle or send a second signal to cause the electrical load to draw power from the electric vehicle based at least on the present output potential, the expected output potential, or both associated with the photovoltaic array, the secondary generation unit, and the energy storage system.

12. The microgrid system of claim 9, wherein the dynamic microgrid management circuitry is configured to determine the present output potential, the expected output potential, or both associated with the photovoltaic array, the secondary generation unit, and the energy storage system based on a data set of similar microgrid systems.

13. The microgrid system of claim 9, wherein the dynamic microgrid management circuitry is configured to determine the present power consumption rates associated with the electrical load based on a data set of similar microgrid systems.

14. The microgrid system of claim 9, wherein the secondary generation unit comprises a fuel cell and/or home standby generator.

15. Tangible, non-transitory, computer-readable media, comprising instructions that, when executed by one or more processors, cause the processors to:
receive an indication of weather conditions, energy market conditions, or both;
determine a presence of a plurality of power resources in a microgrid system;
determine present output potential, expected output potential, or both associated with each respective power resource of the plurality of power resources;
determine present cost, expected cost, or both associated with each respective power resource of the plurality of power resources based on the indications of the weather conditions and the energy market conditions;
determine a plurality of electrical loads associated with the microgrid system;
determine present power consumption rates associated with each electrical load of the plurality of electrical loads;
determine present and expected power consumption costs associated with each electrical load of the plurality of electrical loads based on the indications of the weather conditions and the energy market conditions; and
perform an action to decrease cost of operating the microgrid system; increase efficiency of the microgrid system, or both.

16. The tangible, non-transitory, computer-readable media of claim 15, wherein the action comprises determining excess power generated by one or more electric power resources of the plurality of power resources and sending an input signal to the plurality of power resources, causing the power resources to export at least a portion of the excess power to a power grid based on the indication of the weather conditions and the energy market conditions.

17. The tangible, non-transitory, computer-readable media of claim 15, wherein the action comprises determining an amount of energy stored in a battery system, and sending an input signal to the battery system, causing the battery system to export at least a portion of the amount of energy stored in the battery system to a power grid based on the indication of the weather conditions and the energy market conditions.

18. The tangible, non-transitory, computer-readable media of claim 15, wherein the action comprises determining excess power generated by one or more electric power resources of the plurality of power resources, and sending an input signal to the power resources, causing the power resources to store excess power in a battery based on the indication of the weather conditions and the energy market conditions.

19. The tangible, non-transitory, computer-readable media of claim 15, wherein the instructions, when executed by the one or more processors, cause the one or more processors to:
determine an expected output potential of the microgrid system based on the expected output potential associated with each respective power resource of the plurality of power resources; and
send an input signal to load control circuitry coupled to the plurality of electrical loads, the input signal causing the load control circuitry to shed one or more electrical loads of the plurality of electrical loads based on determining that the expected output potential of the microgrid system falls below a threshold power output.

20. The tangible, non-transitory, computer-readable media of claim 15, wherein the instructions, when executed by the one or more processors, cause the one or more processors to:
determine that the microgrid system is in an off-grid mode; and
send an input signal to load control circuitry coupled to the plurality of electrical loads, the input signal causing the load control circuitry to shed one or more electrical loads of the plurality of electrical loads based on determining that the microgrid system is in the off-grid mode.
